(19) United States
(12) Patent Application Publication
(10) Pub. No.: US 2009/0178577 A1
(43) Pub. Date: Jul. 16, 2009

(54) ROTISSERIE OVEN WITH HIGH TEMPERATURE LIGHT GASKET

(76) Inventors: Richard D. Valentine, Hillsboro, OH (US); Matthew A. Weber, Springboro, OH (US); James M. Heiser, Hillsboro, OH (US); Jeffrey Cooney, Cold Springs, KY (US); Paul A. Scherrer, Hebron, KY (US)

Correspondence Address: THOMPSON HINE LLP;Intellectual Property Group, P.O Box 8801, DAYTON, OH, 45401-8801, US

(21) Appl. No.: 12/324,004

(22) Filed: Nov. 26, 2008

Related U.S. Application Data
(60) Provisional application No. 61/021,111, filed on Jan. 15, 2008.

(51) Int. Cl. A47J 37/04; A21B 3/00; B32B 3/04

(52) U.S. Cl. 99/421 H; 219/402; 156/216

(57) ABSTRACT

A rotisserie oven includes a cooking chamber and a rotor within the cooking chamber. A heating system heats the cooking chamber. A light assembly includes a light source located in a light compartment and a window configured to allow light to illuminate the cooking chamber. A gasket seals the interior of the light compartment from the cooking chamber. The gasket includes a core formed of a first material and an overwrap surrounding the core. The overwrap is formed of a second material different from the first material.

### CROSS REFERENCE TO RELATED APPLICATIONS

This application claims the benefit of U.S. Application No. 61/021,111, filed Jan. 15, 2008, and herein incorporated by reference.

### TECHNICAL FIELD

This application relates generally to ovens used for cooking food product and, more specifically, to a rotisserie oven with a high temperature light gasket.

### BACKGROUND

Various types of ovens are used for cooking food product. Typically lights are provided for the cooking area, and the metal-to-glass seal around the edge of the light windows are covered by a gasket or other sealing mechanism. Traditionally, a rubber gasket is used that is conditioned to withstand the high temperatures associated with the cooking environment.

Rotisserie ovens are commonly used in the retail environment to cook chickens and other food products in a manner that permits store customers to view the food product during cooking. Rotisserie style cooking tends to result in grease, juices and food particles within the oven that require the oven to be cleaned regularly. A self cleaning system is therefore an advantageous addition to a rotisserie oven. However, the detergents and wash chemicals associated with the self cleaning process degrade many seal materials, including those normally employed for the light gasket.

Similarly, many seal materials suitable to contact detergents and wash chemicals are unsuitable for the cooking environment of an oven because of the high temperatures.

It would be desirable to provide an oven such as a rotisserie oven with a suitable light gasket material which can withstand both the temperatures and the chemicals associated with an oven cooking chamber that includes a self-cleaning system.

### SUMMARY

In an aspect, a self-cleaning rotisserie oven includes a cooking chamber and a rotor within the cooking chamber. A heating system heats the cooking chamber. A self-cleaning system exposes the walls of the cooking chamber to wash chemicals during cleaning. A light assembly includes a light source located in a light compartment and a window configured to allow light to illuminate the cooking chamber. A gasket seals the interior of the light compartment from the cooking chamber. The gasket includes a core formed of a first material and an overwrap surrounding the core. The overwrap is formed of a second material different from the first material.

In another aspect, a method of forming a gasket for sealing a light assembly in a cooking chamber of a rotisserie oven is provided. The method includes forming a first sheet material comprising a first material. A second sheet material is formed including the first material. The second sheet material is formed to have a dimension that is greater than a dimension of the first sheet material providing a folding portion. A core is formed including a second material different than the first material. The core is located between the first sheet material and the second sheet material. The folding portion of the second sheet material is bent over edges of the first sheet material and the core thereby overwrapping the core with the first and second sheet material.

### BRIEF DESCRIPTION OF THE DRAWINGS

FIG. 1 is a front perspective of a rotisserie system;

FIG. 2 is a front perspective of another embodiment of a rotisserie system;

FIG. 3 is a schematic side view of one embodiment of a cooking chamber;

FIG. 4 shows a floor of a cooking chamber including a spray arm assembly and drain manifolds;

FIG. 5 shows an exploded perspective view of a light gasket;

FIG. 6 shows a perspective front view of the assembled light gasket;

FIG. 6A shows a diagrammatic sectional view of the assembled light gasket along line A-A of FIG. 6;

FIG. 7 shows a perspective rear view of the assembled light gasket;

FIG. 8 shows an exemplary light installation with a gasket; and

FIG. 9 is a bottom view of the light installation of FIG. 8.

### DETAILED DESCRIPTION

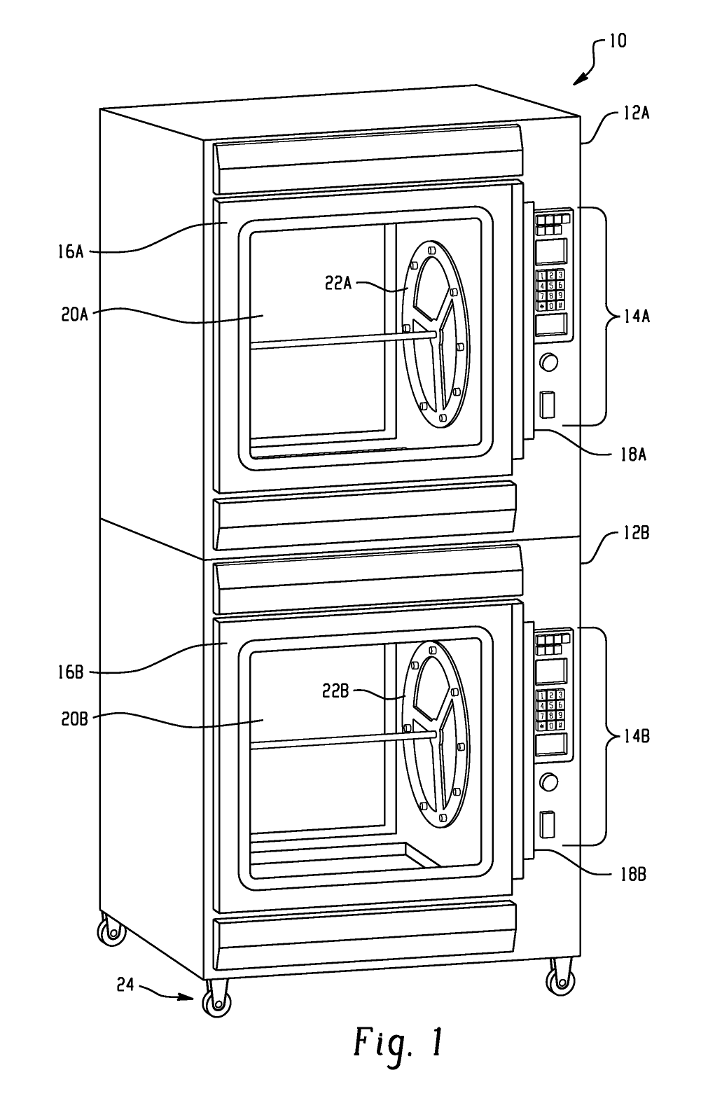

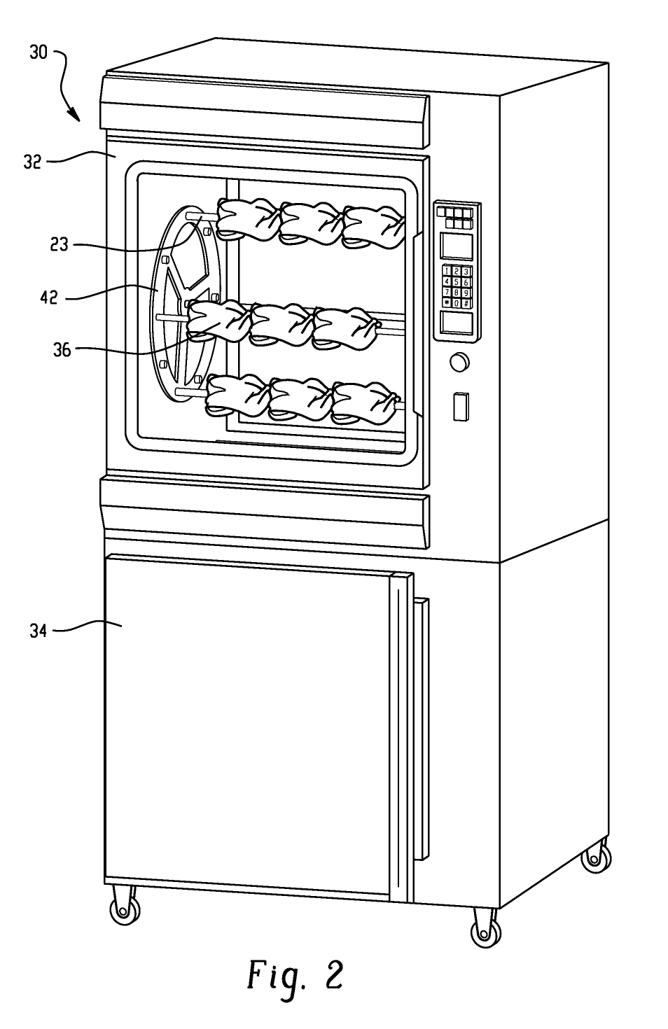

Referring to FIG. 1, a rotisserie system 10 is shown including a rotisserie oven 12A stacked atop another rotisserie oven 12B. Each oven includes a respective control interface 14A, 14B, which may include a variety of components, such as an information display area, a numeric keypad, ON/OFF buttons/keys, function specific buttons/keys, and/or various indicator lights. Each oven includes a vertically hinged access door 16A, 16B with a respective handle 18A, 18B and glass front 20A, 20B for viewing the rotisserie operation. The rear side of the oven may also include a viewing window, and in some cases may be formed by a rear door. A rotor 22A, 22B within each oven is also shown. The rotor 22A and 22B rotates a spit 23 that carries food products, such as chickens during cooking (see FIG. 2). The illustrated system is supported by wheels 24 for ease in repositioning the system, with one or more of the wheels 24 including a lock feature. Referring to FIG. 2, a rotisserie system 30 is shown with a single oven 32 stacked atop a lower cabinet 34. The rotor 42 within oven 32 includes birds 36 loaded thereon as per a typical rotisserie cooking operation.

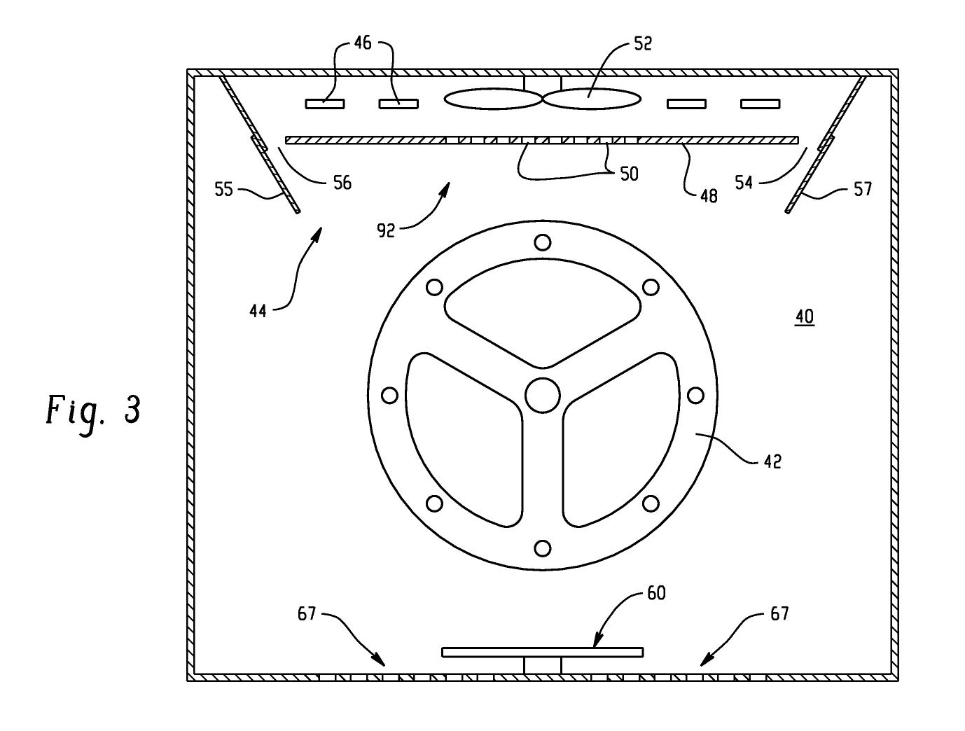

FIG. 3 is a side view layout showing an exemplary oven chamber 40. During rotisserie cooking operations, the rotor 42 rotates as heat is generated by a heating system 44. In the illustrated embodiment, the heating system 44 is formed by heating elements 46 located above an upper plate or shield 48. The plate 48 includes one or more intake openings 50 with associated convection fans 52 arranged to draw air into the openings 50 from the chamber 40. The fans 52 push the air forward and rearward and across the heating elements 46 to pick up heat. The heated air is then directed back into the chamber 40 at forward and rearward slots 54 and 56. Baffles 55 and 57 guide the air inward toward the rotor 42 at the center of the chamber 40 as the heated air passes through the ventilation slots 54 and 56. The space above the plate 48 may include other directional plates or baffles to more effectively produce the forward and rearward air flow.

The rotisserie oven includes a self-cleaning feature that enables the oven to be cleaned during a self-cleaning mode of operation. For this purpose the oven may generally have hook-ups to a source of water and cleaning agent, and may also include a drain path and hook-up to enable the cleaning water to be purged during various points of the cleaning operation. The cleaning operation may include one or more stages, including pre-wash, wash and/or rinse stages. Different cleaning modes (e.g., which may provide different levels of cleaning) may be provided for user selection based upon the user's observation of how clean or dirty the oven is prior to cleaning.

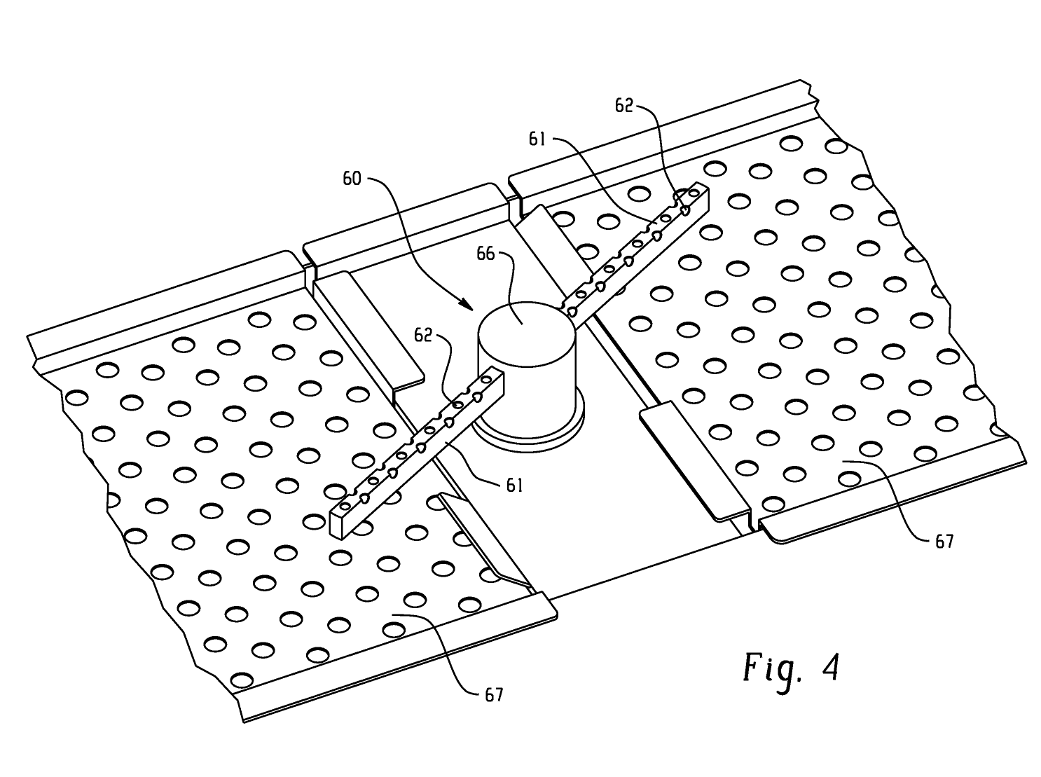

In one implementation the self-cleaning feature includes the use of a spray arm assembly 60, shown in FIG. 3 at a bottom portion of the cooking chamber 40. As shown in FIG. 4, the spray arm assembly 60 includes a rotatable spray arm hub 66 upon which is mounted one or more spray arms 61. Each spray arm 61 includes a multiplicity of nozzle openings 62 for ejecting sprays of water during cleaning, and the force of the ejected water urges each arm 61 to rotate. Water is evacuated from the bottom of the chamber 40 through use of the drain manifolds 67, which lead to a lower sump area where cleaning liquid collects for recirculation via a pump. Other stationary and/or rotating wash arms and/or nozzles could also be located elsewhere within the oven chamber 40 and/or above the plate 48.

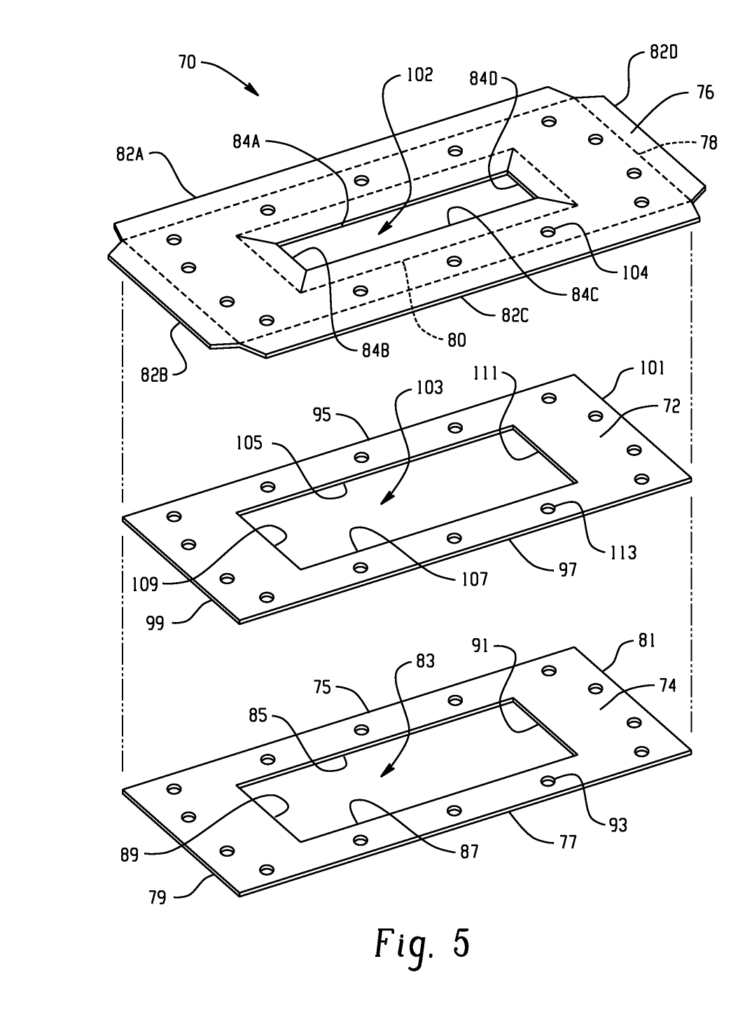

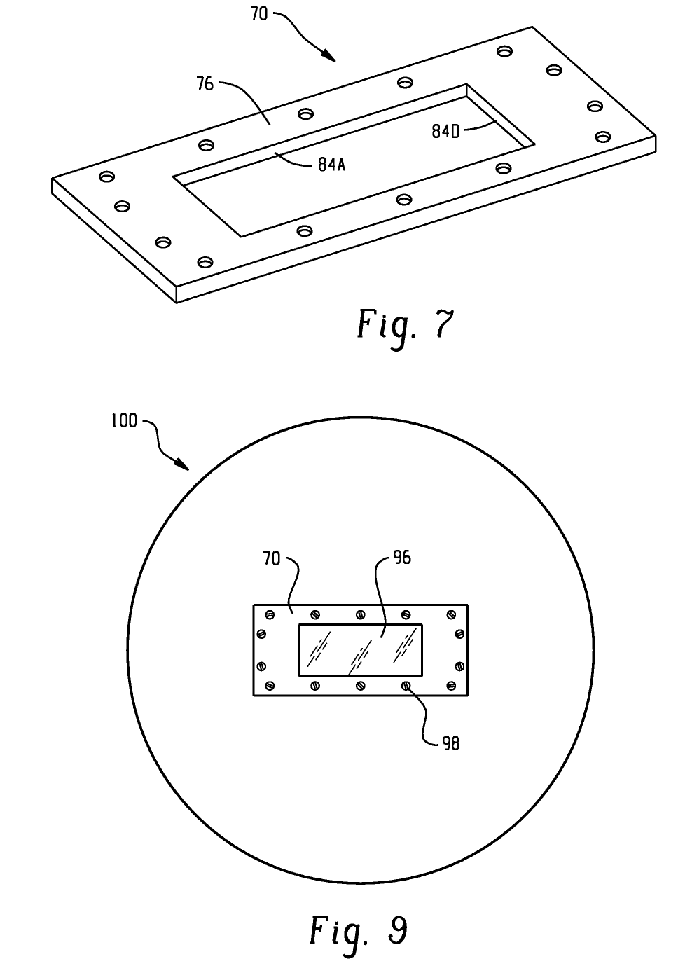

Referring to FIGS. 5-7, a high temperature light gasket 70 is shown. The gasket includes a flexible graphite core and a thin (e.g., about 1.5 mil) stainless steel overwrap. The stainless steel overwrap provides additional support and protection for the somewhat brittle flexible graphite core. It also isolates the graphite core from the oven cavity to prevent flaking of the graphite material, and allows sufficient conformability for sealing.

Referring to the exploded perspective view of FIG. 5, in one embodiment the gasket 70 is a three component assembly formed by a graphite core 72, and two distinct pieces of stainless steel 74 and 76, which are assembled together to sandwich the graphite core 72. The lower stainless sheet 74 is generally rectangular in shape and includes a first pair of opposing sides 75 and 77 and a second pair of opposing sides 79 and 81. An opening 83 extends through the lower stainless steel sheet 74 and is bordered by sides 85, 87, 89 and 91. Fastener openings 93 are disposed about the opening 83. The lower stainless steel sheet 74 has a footprint that substantially matches that of the core 72.

The core 72 is also generally rectangular in shape and includes a first pair of opposing sides 95 and 97 and a second pair of opposing sides 99 and 101. An opening 103 extends through the lower stainless steel sheet 74 and is bordered by sides 105, 107, 109 and 111. Fastener openings 113 are disposed about the opening 103.

As formed, the upper stainless sheet 76 has a footprint that is larger than those of the lower stainless steel sheet 74 and the core 72, as demonstrated by the representative core footprint shown by dashed lines 78 and 80. Specifically, exterior side portions 82A, 82B, 82C and 82D extend outward beyond the exterior footprint line 78, and interior side portions 84A, 84B, 84C and 84D extend inward beyond the cutout footprint line 80. The upper stainless steel sheet 76 includes an opening 102 that aligns with openings 83 and 103 and fastener openings 104 that align with fastener openings 93 and 113.

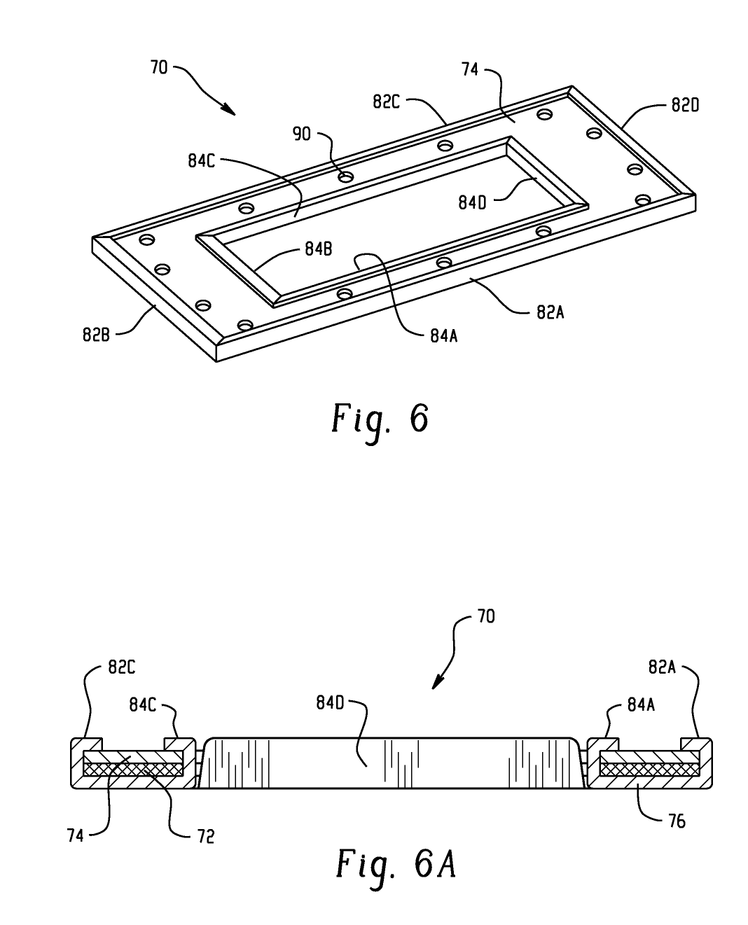

To assemble the gasket 70, the core 72 and lower stainless sheet 74 are held together with footprints aligned. The upper stainless sheet 76 is then placed over the core 72 with dashed line portions 78 and 80 aligned with the actual core footprint. The side portions 82 and 84 are then wrapped over the respective sides of the core 72 and around the core and over the respective sides of the lower sheet 74 and around the lower sheet to hold the assembly together as a unit. The overwrap of the side portions 82 and 84 can be seen in the view of FIG. 6A.

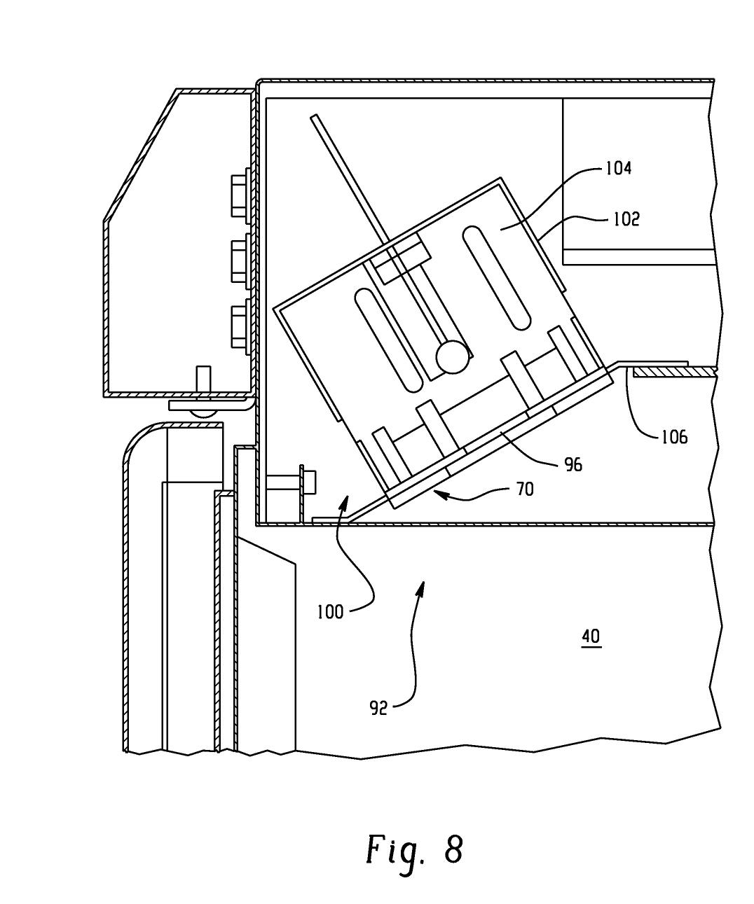

Referring to FIGS. 5-7, the fastener openings 93, 104 and 113 align to form openings 90 provided in the assembled gasket allow for the passage of fasteners therethrough when the gasket is mounted to shield a light of the oven chamber. Referring to FIG. 3, the light may be located in an upper, forward location 92 of the oven, but other locations are possible. Likewise, a light may also be located toward an upper, rearward location 94 of the oven. FIG. 8 shows a light installation 100 in more detail, with the gasket 70 used to seal the light from liquid. The light installation 100 includes a recessed compartment 102 proximate the top wall 106 of the rotisserie chamber 40. FIG. 9 shows a bottom view of the light installation with the gasket 70 surrounding a window 96 (e.g., a lens or glass plate) of the light assembly. Fasteners 98 are used to fasten the gasket 70 around the window 96 at the periphery of the compartment 102. The gasket 70 seals interior 104 of compartment 102 from the oven chamber 40.

The gasket assembly described above meets advantageous technical requirements of a self-cleaning rotisserie application, and continues to meet these requirements for the expected life of the oven. The sealing surface temperature exceeds 650° F. The gasket exhibits a resistance to an alkaline environment including sodium hydroxide, as well as a resistance to the residue and vapors associated with chicken fatty acids and other rotisserie byproducts. The gasket also meets the regulatory requirements for food contact, and conforms well to the slightly irregular surface of the cooking chamber wall at the point of the glass-to-metal seal.

It is to be clearly understood that the above description is intended by way of illustration and example only, is not intended to be taken by way of limitation. For example, the rotisserie oven can be stacked as shown in FIG. 1, located on a stand as shown by FIG. 2, located atop a counter, located atop a combination oven, located atop a convection oven, etc. In some embodiments, the rotor 42 may rotate baskets that hold the food product instead of spits. Accordingly, other changes and modifications are possible.

What is claimed is:

1. A rotisserie oven, comprising:
a cooking chamber;
a rotor within the cooking chamber;
a heating system that heats the cooking chamber;
a light assembly comprising a light source located in a light compartment and a window configured to allow light to illuminate the cooking chamber;
a gasket sealing the interior of the light compartment from the cooking chamber, the gasket comprising a core formed of a first material and an overwrap surrounding the core, the overwrap being formed of a second material different from the first material.

2. The rotisserie oven of claim 1, wherein the overwrap comprises a first sheet member and a second sheet member, the first and second sheet members being formed as separate components that are joined to form the overwrap by bending a portion of the first sheet member over side edges of the core and second sheet member.

3. The rotisserie oven of claim 2, wherein the first sheet member includes first and second opposite sides and third and fourth opposite sides, each first, second, third and fourth side of the first sheet member having an associated portion that is bent over side edges of the core and second sheet member.

4. The rotisserie oven of claim 3, wherein the first sheet member, the second sheet member and the core have central openings that are aligned to expose the window, the first sheet member including an interior portion adjacent the central opening of the first sheet member that is bent over interior side edges of the core and the second sheet member, the interior side edge of the core bordering the central opening of the core and the interior side edge of the second sheet member bordering the central opening of the second sheet member.

5. The rotisserie oven of claim 2, wherein the second sheet member has a surface area that is substantially the same as a surface area of the core, the first sheet member having a surface area greater than the second sheet member and the core.

6. The rotisserie oven of claim 1, wherein the first material comprises graphite and the second material comprises stainless steel.

7. The rotisserie oven of claim 1, wherein the overwrap is no more than about 1.5 mil in thickness.

8. The rotisserie oven of claim 1, wherein the rotisserie oven is self-cleaning and includes a self-cleaning system that provides wash chemicals to the walls of the cooking chamber during cleaning.

9. A method of forming a gasket for sealing a light assembly in a cooking chamber of a rotisserie oven, the method comprising:
forming a first sheet material comprising a first material;
forming a second sheet material comprising the first material, the second sheet material having a dimension that is greater than a dimension of the first sheet material providing a folding portion;
forming a core comprising a second material different than the first material;
locating the core between the first sheet material and the second sheet material; and
bending the folding portion of the second sheet material over edges of the first sheet material and the core thereby overwrapping the core with the first and second sheet material.

10. The method of claim 9 wherein the step of forming the second sheet material comprises forming the second sheet material to include first and second opposite sides and third and fourth opposite sides, each first, second, third and fourth side of the first sheet member having an associated folding portion.

11. The method of claim 10 further comprising bending the folding portions over edges of the first sheet material and the core.

12. The method of claim 11 comprising forming the first sheet member, the second sheet member and the core have central openings to be aligned to expose the lens, the step of forming the second sheet member includes forming the first sheet member with an interior portion adjacent the central opening of the first sheet member and bending the interior portion of the second sheet member over interior side edges of the core and the first sheet member, the interior side edge of the core bordering the central opening of the core and the interior side edge of the first sheet member bordering the central opening of the second sheet member.

13. The method of claim 9, wherein the step of forming the first sheet member includes forming the first sheet member having a surface area that is substantially the same as a surface area of the core, the step of forming the second sheet member comprising forming the second sheet member having a surface area greater than the surface area of the first sheet member.

14. The method of claim 9, wherein the first material comprises graphite and the second material comprises stainless steel.

15. The method of claim 9, wherein the steps of forming the first and second sheet members comprise forming the first and second sheet members having a thickness of no more than about 1.5 mil.
